(19) United States
(12) Patent Application Publication
(10) Pub. No.: US 2004/0228532 A1
(43) Pub. Date: Nov. 18, 2004

(54) Instant messaging ink and formats

(75) Inventors: Roland Fernandez, Woodinville, WA (US); Iain Hackett, Port Vila (VU); Wistar D. Rinearson, Redmond, WA (US); Michael Williams, Seattle, WA (US); Susan D. Woolf, Seattle, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/437,230

(22) Filed: May 14, 2003

(51) Int. Cl. G06K 9/00; G06K 9/22; G09G 5/00; G06F 15/16; H04M 1/64

(52) U.S. Cl. 382/187; 382/314; 345/179; 345/173; 709/206; 709/219; 379/88.17

(57) ABSTRACT

User interfaces and methods are described for formatting and handling electronic ink messaging communications.

### BACKGROUND OF THE INVENTION

1. Field of the Invention

Aspects of the present invention relates to communication techniques. More specifically, aspects of the present invention relate to information entry and formats for instant messaging applications.

2. Description of Related Art

Typical computer systems, especially computer systems using graphical user interface (GUI) systems, such as Microsoft WINDOWS, are optimized for accepting user input from one or more discrete input devices such as a keyboard for entering text, and a pointing device such as a mouse with one or more buttons for driving the user interface.

Some computing systems have expanded the input and interaction systems available to a user by allowing the use of a stylus to input information into the systems. The stylus may take the place of both the keyboard (for data entry) as well as the mouse (for control). Some computing systems receive handwritten electronic information or electronic ink and immediately attempt to convert the electronic ink into text. Other systems permit the electronic ink to remain in the handwritten form.

Instant messaging applications currently exist. AOL® Instant Messenger™ 5.1 and MSN® Instant Messenger 5.0 are messaging applications that permit to one to transmit text, images, and other files to people on one's contact list. Other instant messaging applications are available. One common aspect of these instant messaging applications is that they all are limited to text as the primary information to be exchanged. If one wants to transfer an image or a file, one needs to request the recipient to accept the file. Stylus-based computing is not always predicated on the ability to input text. Accordingly, instant messaging applications need to be able to handle electronic ink from stylus-based computing applications as easily as they handle text.

Further, instant messaging is becoming increasingly popular as users are able to send and receive instant messages from portable devices. These portable devices include cell phones, personal data assistants, handheld computers and notebook computers. A number of these devices do not include full-fledged keyboards, but rather rely on a minimal keyboard or a stylus-based input system to receive information from a user. Instant messaging services need to be able to accommodate stylus-based input without creating hassles for users.

### BRIEF SUMMARY

Aspects of the present invention address one or more of the issues mentioned above, thereby providing a better instant messaging environment. Aspects of the present invention include the ability to transmit electronic ink through instant messaging communications. In some aspects, a user is provided with the ability to input electronic ink in a first region and have the ink displayed in a history window upon sending an instant message transmission. In some aspects, a user may be provided with the ability to modify the ink after being deposited and possibly clear the ink. In other aspects, the ink may be formatted in at least one of a native ink format and a graphical format, for display on at least one of an ink enabled instant messaging system and a non-ink enabled instant messaging system. In yet further aspects, a user may insert text or other data types or streams in combination with the ink.

These and other aspects are addressed in relation to the Figures and related description.

### BRIEF DESCRIPTION OF THE DRAWINGS

Aspects of the present invention are illustrated by way of example and not limited in the accompanying figures.

FIG. 1 shows a general-purpose computer supporting one or more aspects of the present invention.

FIG. 2 shows a display for a stylus-based input system according to aspects of the present invention.

FIG. 3 shows a region for receiving electronic ink and a history window in accordance with aspects of the present invention.

FIG. 4 shows a process for transmitting an instant message with ink information in accordance with aspects of the present invention.

FIG. 5 shows an ink input region with both text and ink in accordance with embodiments of the present invention.

FIG. 6 shows ink and text disposed in separate layers in accordance with aspects of the present invention.

FIG. 7 shows an illustrative network topology in accordance with aspects of the present invention.

### DETAILED DESCRIPTION OF THE DRAWINGS

Aspects of the present invention relate to receiving and displaying electronic ink in instant messages. The ink may be a resident ink format or may be a graphical image of the ink. Aspects of the present invention also permit the modification of the ink when it is being deposited as well as clearing a history window. Further aspects of the present invention permit text to be incorporated with ink in instant messages. This document is divided into headings to assist the user in understanding aspects of the present invention. These headings include: characteristics of ink; terms; general-purpose computing environment; electronic ink and instant messages; and electronic ink and text.

Characteristics of Ink

As known to users who use ink pens, physical ink (the kind laid down on paper using a pen with an ink reservoir) may convey more information than a series of coordinates connected by line segments. For example, physical ink can reflect pen pressure (by the thickness of the ink), pen angle (by the shape of the line or curve segments and the behavior of the ink around discreet points), and the speed of the nib of the pen (by the straightness, line width, and line width changes over the course of a line or curve). Because of these additional properties, emotion, personality, emphasis and so forth can be more instantaneously conveyed than with uniform line width between points.

Electronic ink (or ink) relates to the capture and display of electronic information captured when a user uses a stylus-based input device. Electronic ink refers to a sequence of strokes, where each stroke is comprised of a sequence of points. The points may be represented using a variety of known techniques including Cartesian coordinates (X, Y), polar coordinates (r, T), and other techniques as known in the art. Electronic ink may include representations of properties of real ink including pressure, angle, speed, color, stylus size, and ink opacity. Electronic ink may further include other properties including the order of how ink was deposited on a page (a raster pattern of left to right then down for most western languages), a timestamp (indicating when the ink was deposited), indication of the author of the ink, and the originating device (at least one of an identification of a machine upon which the ink was drawn or an identification of the pen used to deposit the ink) among other information.

Terms

Ink-A sequence or set of strokes with properties. A sequence of strokes may include strokes in an ordered form. The sequence may be ordered by the time captured or by where the strokes appear on a page or in collaborative situations by the author of the ink. Other orders are possible. A set of strokes may include sequences of strokes or unordered strokes or any combination thereof. Further, some properties may be unique to each stroke or point in the stroke (for example, pressure, speed, angle, and the like). These properties may be stored at the stroke or point level, and not at the ink level

Ink object-A data structure storing ink with or without properties.

Stroke-A sequence or set of captured points. For example, when rendered, the sequence of points may be connected with lines. Alternatively, the stroke may be represented as a point and a vector in the direction of the next point. In short, a stroke is intended to encompass any representation of points or segments relating to ink, irrespective of the underlying representation of points and/or what connects the points.

Point-Information defining a location in space. For example, the points may be defined relative to a capturing space (for example, points on a digitizer), a virtual ink space (the coordinates in a space into which captured ink is placed), and/or display space (the points or pixels of a display device).

General-Purpose Computer

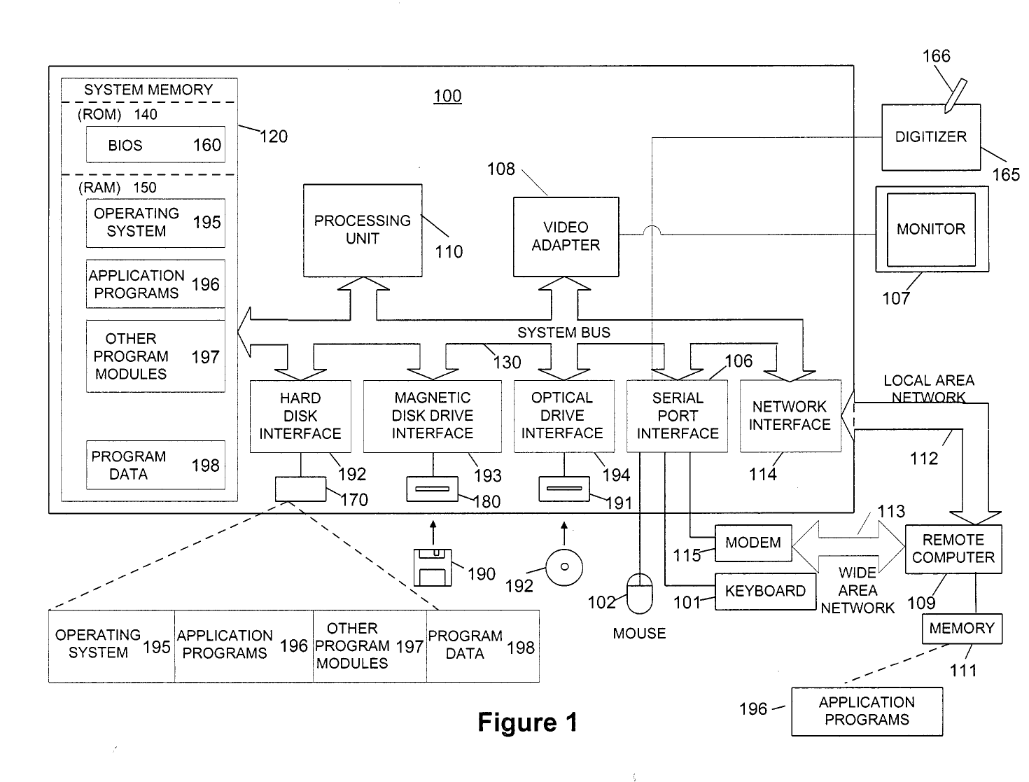

FIG. 1 illustrates a schematic diagram of an illustrative conventional general-purpose digital computing environment that can be used to implement various aspects of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers. In a one embodiment, a pen digitizer 165 and accompanying pen or stylus 166 are provided in order to digitally capture freehand input. Although a direct connection between the pen digitizer 165 and the serial port interface 106 is shown, in practice, the pen digitizer 165 may be coupled to the processing unit 110 directly, parallel port or other interface and the system bus 130 by any technique including wirelessly. Also, the pen 166 may have a camera associated with it and a transceiver for wirelessly transmitting image information captured by the camera to an interface interacting with bus 130. Further, the pen may have other sensing systems in addition to or in place of the camera for determining strokes of electronic ink including accelerometers, magnetometers, and gyroscopes.

Furthermore, although the digitizer 165 is shown apart from the monitor 107, the usable input area of the digitizer 165 may be co-extensive with the display area of the monitor 107. Further still, the digitizer 165 may be integrated in the monitor 107, or may exist as a separate device overlaying or otherwise appended to the monitor 107.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device. Further, the system may include wired and/or wireless capabilities. For example, network interface 114 may include Bluetooth, SWLan, and/or IEEE 802.11 class of combination abilities. It is appreciated that other wireless communication protocols may be used in conjunction with these protocols or in place of these protocols.

It will be appreciated that the network connections shown are illustrative and other techniques for establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

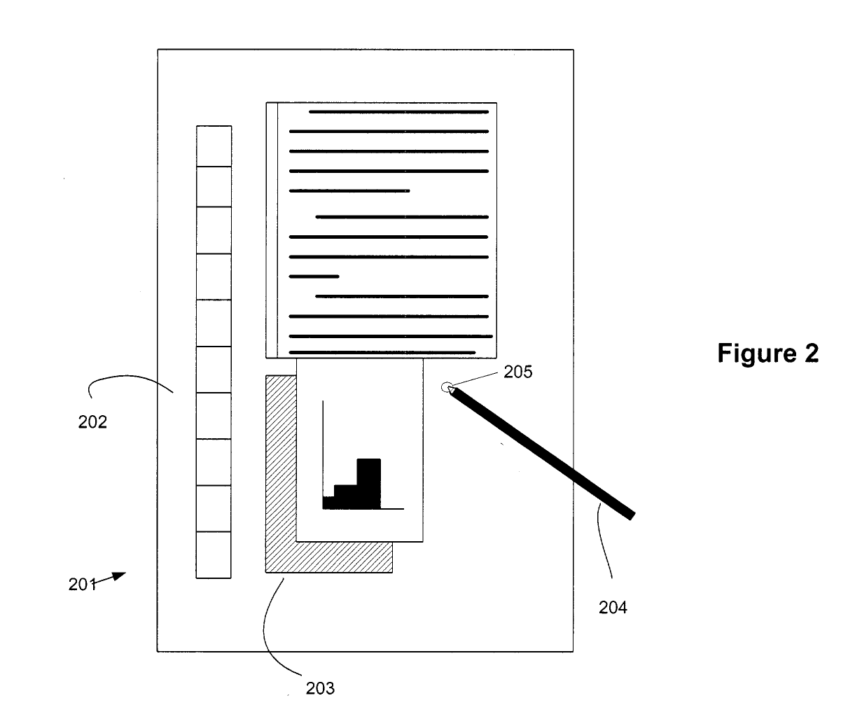

FIG. 2 illustrates an illustrative tablet PC 201 that can be used in accordance with various aspects of the present invention. Any or all of the features, subsystems, and functions in the system of FIG. 1 can be included in the computer of FIG. 2. Tablet PC 201 includes a large display surface 202, e.g., a digitizing flat panel display, preferably, a liquid crystal display (LCD) screen, on which a plurality of windows 203 is displayed. Using stylus 204, a user can select, highlight, and/or write on the digitizing display surface 202. Examples of suitable digitizing display surfaces 202 include electromagnetic pen digitizers, such as Mutoh or Wacom pen digitizers. Other types of pen digitizers, e.g., optical digitizers, may also be used. Tablet PC 201 interprets gestures made using stylus 204 in order to manipulate data, enter text, create drawings, and/or execute conventional computer application tasks such as spreadsheets, word processing programs, and the like.

The stylus 204 may be equipped with one or more buttons or other features to augment its selection capabilities. In one embodiment, the stylus 204 could be implemented as a “pencil” or “pen”, in which one end constitutes a writing portion and the other end constitutes an “eraser” end, and which, when moved across the display, indicates portions of the display are to be erased. Other types of input devices, such as a mouse, trackball, or the like could be used. Additionally, a user's own finger could be the stylus 204 and used for selecting or indicating portions of the displayed image on a touch-sensitive or proximity-sensitive display. Consequently, the term “user input device”, as used herein, is intended to have a broad definition and encompasses many variations on well-known input devices such as stylus 204. Region 205 shows a feedback region or contact region permitting the user to determine where the stylus 204 as contacted the display surface 202.

In various embodiments, the system provides an ink platform as a set of COM (component object model) services that an application can use to capture, manipulate, and store ink. One service enables an application to read and write ink using the disclosed representations of ink. The ink platform may also include a mark-up language including a language like the extensible markup language (XML). Further, the system may use DCOM as another implementation. Yet further implementations may be used including the Win32 programming model and the .Net programming model from Microsoft Corporation.

Electronic Ink and Instant Messages

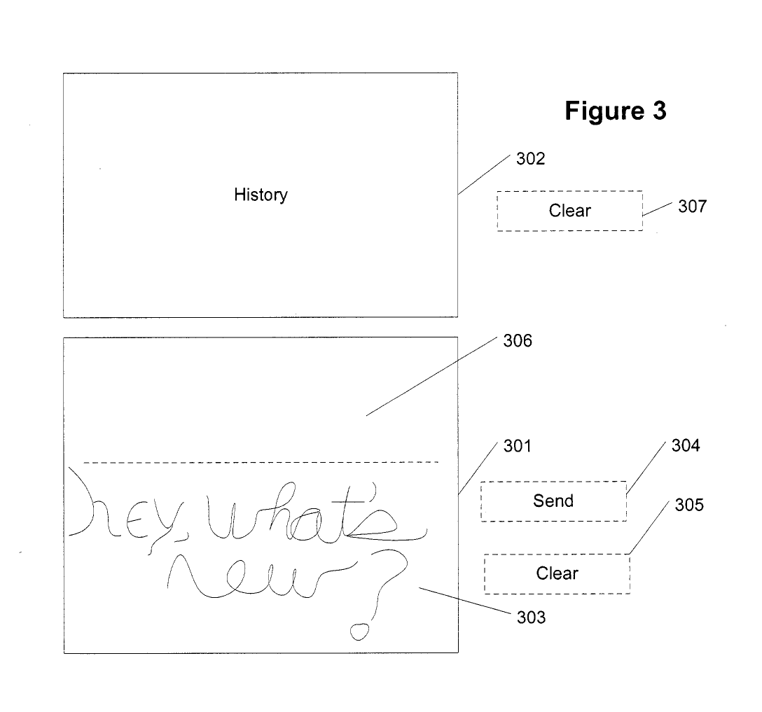

FIG. 3 shows a region for receiving electronic ink and a history window in accordance with aspects of the present invention. FIG. 3 includes a region 301 for receiving electronic ink. A user may use a stylus to draw on a screen and have electronic ink created relating to the movement of a stylus. The electronic ink may be generated in response to the tip of a stylus in relation to a digitizer or in relation to information transmitted from a stylus including at least one of image information and position information.

FIG. 3 also shows region 302 that displays a history of an instant messaging conversation between two or more people. History region 302 may be displayed at the same time as ink receiving region 301 or may be displayed when region 301 is not displayed. Further, in some aspects, regions 301 and 302 may be combined to provide a seamless instant messaging display region, more akin to writing notes on paper then entering information into a computer.

Region 301 may be the only display of ink being currently created. Alternatively, region 301 may be sub-divided into regions 303 and 306, where region 303 receives ink from a user and region 306 receives ink from a remote user currently in the process of being deposited. By including both regions 303 and 306, a user is a better able to know the current thoughts of a remote user.

When creating electronic ink for instant messaging communications, an instruction to transmit ink from region 301 to a remote user (and possibly to display received ink in history window at 302) may be in the form of a gesture to transmit the electronic ink. For example, withdrawing a stylus away from region 301 may be a gesture to transmit any ink in region 301 to a remote user. Additionally or alternatively, a user may be provided with send region 304. Upon selection or interaction with send region 304, ink in region 301 may be transmitted to a remote user.

A user may be provided with the option to modify ink received in region 301. For example, a user may be able to gesture to erase small portions of received ink. Alternatively, one may interact with erase region 305 and use of the stylus be interpreted as erasing all ink contacted by the tip of the stylus. Further, erasing may occur through modification of the stylus including but not limited to flipping the stylus over and using an alternative pen tip, clicking an available actuator button on the stylus, and/or using an alternative stylus for erasing. Further, a user may be able to completely erase any deposited ink in region 301 by at least one of gesturing for the deletion of the ink and/or tapping a region 306 that clears the received ink.

At times, the current instant messaging communication the user is writing may be long and/or may include personal information that a user wants to eliminate. A user may clear the history window at 302 by using a gesture to eliminate the content of the history window 302 and/or may interact with a region 307 to clear the history window.

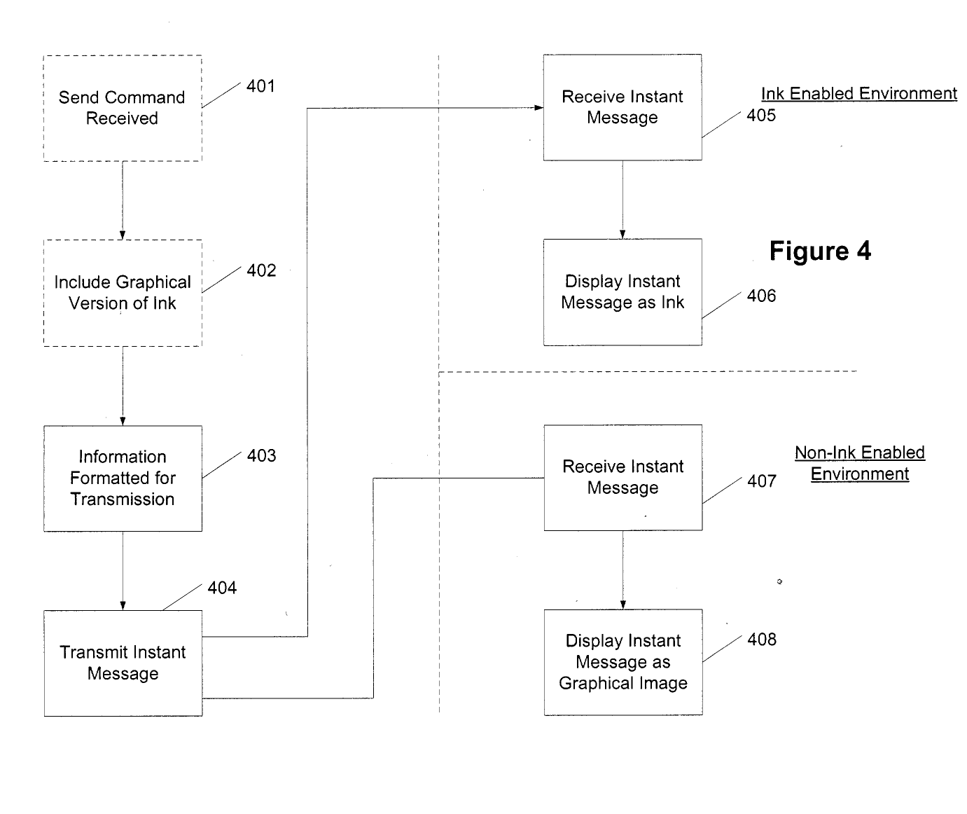

FIG. 4 shows a process for transmitting an instant message with ink information in accordance with aspects of the present invention. In step 401, a system receives a send command to transmit received electronic ink as an instant message. Step 401, which is shown as hatched box around the send command may take many forms as described above. In step 402, a graphical representation of the ink in optionally included. Next in step 403, the information to be transmitted as an instant message is formatted for transmission. This may include at least one of compressing, packetizing, encrypting, and error-checking the information. Next in step 404, the information from step 403 is transmitted to a remote user. The transmission may include passing the information directly to a remote user in a peer-to-peer network or transmitting the information to the remote user through one or more servers.

Next in step 405, the instant message is received. Finally in step 406, the received instant message is displayed. Steps 405 and 406 occur in an ink enabled environment in which a user can display ink in its native format. Accordingly in step 406, the information received from step 405 may be reformatted from the communications stream between steps 404 and 405 and into a native format for ink. Here, for example, the native format for ink may include an ink object or any other form for displaying ink with its related properties. When the ink is received, as a native format, the ink may be manipulated as ink (copy, edit, erase, insert space, recognize as text, change color, chose pen size, change pen type, etc), which cannot be done with just a graphical image.

Further, in yet another aspect of the invention, an ink-enabled receiver of an ink message may also be able to play the ink back over time, showing playback of the speed and strokes made by the writer. Emphasis can be made in writing by speeding up the stroking of certain elements. For example, emphasis may be made by underlining a key term, as shown to a user based on the underlining by the user sending the ink. In such a scheme, the ink playback speed may be fixed. Alternatively, the playback speed may specified by the sender and/or specified by the receiver. For instance, the sender may be able to specify the ink message playback speed with the effective instructions of “send this to my contact Joe and play it back at 300% the speed at which I penned it.”

However, not all users will be able to receive and display ink in a native format. Accordingly, step 402 between steps 401 and 403 may be used to create a graphical version of the ink to be transmitted as an instant message. The graphical version may be displayed in environments that cannot handle a native format for ink. The formatting step 403 may include adding the graphical version of the ink to the ink in its native format. Alternatively, the graphical version of the ink may be used to encompass the native format of the ink. For example, the graphical version of the ink may include comment fields (for example, GIFs, JPEGs, and other file formats), which may be used to store ink in its native format. In step 407, when an instant message is received with a graphical version of the ink, the graphical version may be displayed in step 408 and the native ink information ignored or removed. In steps 405 and 406, the ink enabled environment would recognize the native ink information in the instant message received and display the ink in its native format, as opposed to the graphical version of the ink.

In yet a further aspect of the invention, the identity and ink enabled status of the recipient may be known to a user's machine. With this information, one format of the instant message may be transmitted to a first user and another format of the instant message may be transmitted to a second user, where the first format is an ink enabled format and the second format is a non-ink enabled format.

Electronic Ink and Text

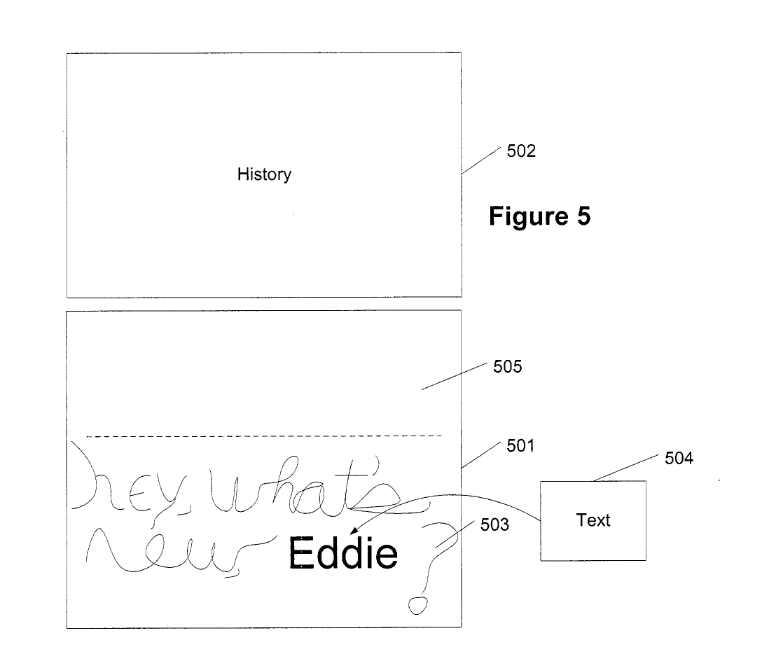

FIG. 5 shows an ink input region with both text and ink in accordance with embodiments of the present invention. At times, one may wish to include text information in an ink instant message. FIG. 5 shows ink region 501 including electronic ink about to be transmitted to a user. The user may wish to include text information along with the ink so as to enclose specified information, without the distraction of the messiness of a person's handwriting. A user may interact with region 502 and have text input into region 501. Interaction with region 502 may include opening up a text input region where handwritten ink may be input, then recognized as text. Alternatively, a soft keyboard may appear, or an attached hard keyboard may be used, and the user may tap on the representations of various keys and have the text associated with the keys be input into region 501. Further, a user may select ink in region 501, hit the text region 502, and have the selected ink be recognized and resultant text input into region 501. The resultant text may supplement or replace the selected ink.

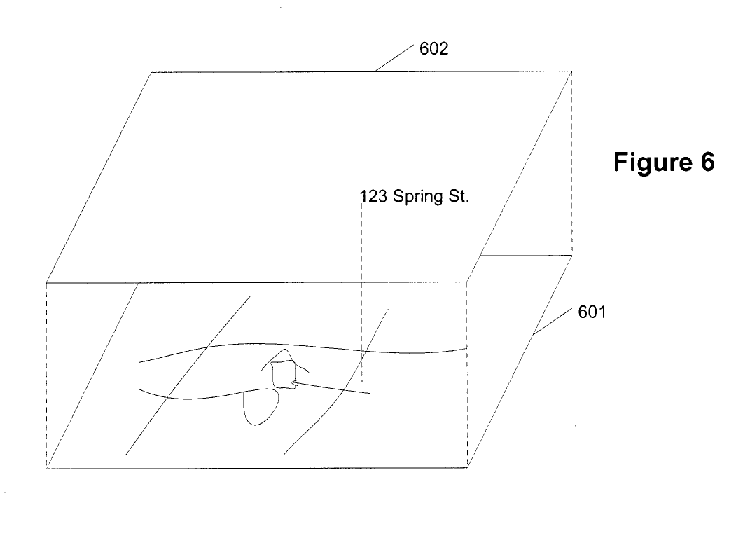

The reader can appreciate that text is not the only data type that may be appropriate to intermix with ink instant messages: video streams and spoken speech are additional data types which could be inserted either as they are or in additional steps recognized and inserted as text. Additional, speech can be recognized and the associated text can be inserted, or the recognized speech can be used as names of objects to insert (ink drawings of named objects, graphic images of names objects, sound files for named objects, and the like). The ink and text may appear in the same layer. Alternatively the ink and text may occur in separate layers. FIG. 6 shows ink and text disposed in separate layers in accordance with aspects of the present invention. A first ink layer 601 receives ink. Another layer 602 receives text which may overlie the ink in layer 601. Accordingly, ink from layer 601 would not obscure text from layer 602. These separate layers can be used to perform separate editing operations: for example, the stylus eraser could be used to edit the ink and the keyboard could be used to edit the text. Alternatively, they could be combined on the same layer and parts of the text could be erased with the style eraser, as well as using the keyboard “backspace” or “delete” key to erase a character-sized square of whatever ink/text lies underneath the cursor.

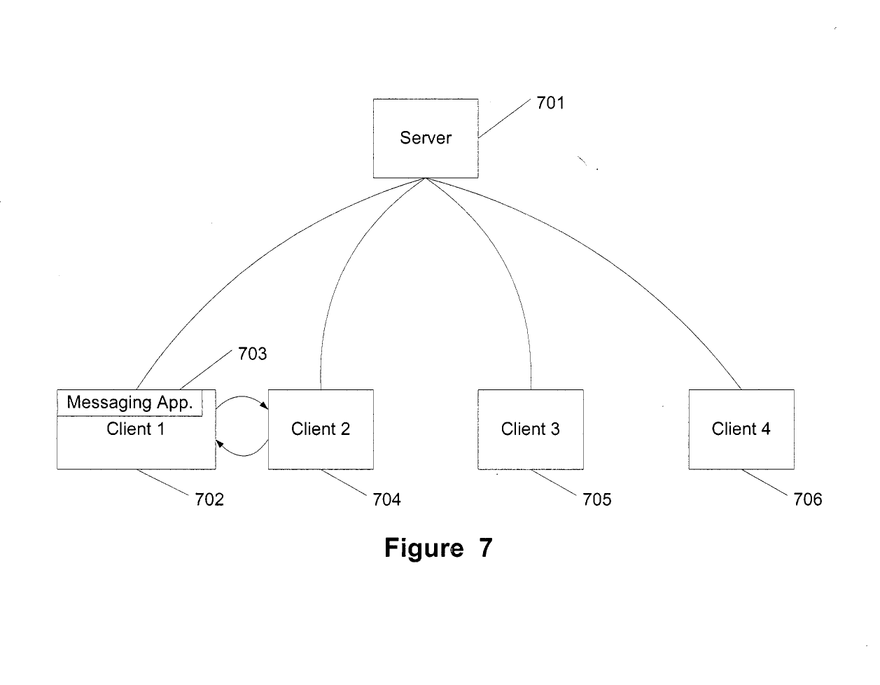

FIG. 7 shows a networked topology in accordance with aspects of the present invention. FIG. 7 includes a server 701 and a number of clients all interconnected through a wired and/or wireless network. The wireless network may include IEEE 802.11* (any of the IEEE 802.11 family of wireless protocols), Bluetooth, and any other wireless protocol. Client 1 702 includes a messaging application 703. The messaging application 703 is responsible for listening for instant messages from other clients or servers and coordinating appropriate application openings and closings. FIG. 7 shows clients 2 704, 3 705, and 4 706. These clients may also have messaging application 703 running as well. Alternatively, they may have other messaging applications running. For example, one may have a messaging application 703 from a first company and another client may have messaging application from a second company. Further, these clients may be connected by server 701 or in a peer-to-peer network.

Aspects of the present invention have been described in terms of illustrative embodiments thereof. Numerous other embodiments, modifications and variations within the scope and spirit of the appended claims will occur to persons of ordinary skill in the art from a review of this disclosure.

We claim:

1. A user interface comprising:
a first region receiving electronic ink;
a second region including a history of an instant messaging conversation,
wherein the electronic ink of the first region may be cleared.

2. The user interface according to claim 1, wherein the clearing of said electronic ink is initiated by a gesture of a stylus.

3. The user interface according to claim 1, wherein the clearing of said electronic ink is initiated by selection of a third region.

4. The user interface according to claim 1, wherein the electronic ink may be erased and where the erasing is initiated by a gesture of a stylus.

5. The user interface according to claim 1, wherein the electronic ink may be erased and where the erasing is initiated by selection of a third region.

6. The user interface according to claim 1, wherein the electronic ink may be sent to another user, wherein the sending is initiated by a gesture of a stylus.

7. The user interface according to claim 1, wherein the electronic ink may be sent to another user, wherein the sending is initiated by selection of a third region.

8. The user interface according to claim 1, wherein the content of said second region may be cleared, where the clearing is initiated by a gesture of a stylus.

9. The user interface according to claim 1, wherein the content of said second region may be cleared, wherein the clearing is initiated by selection of a third region.

10. A user interface for sending instant messages comprising:
a first region receiving electronic ink;
a second region, upon whose selection, text is enabled to be inserted into said first region for an instant message.
